(19) United States
(12) Patent Application Publication
(10) Pub. No.: US 2009/0181337 A1
(43) Pub. Date: Jul. 16, 2009

(54) Wire disengagement instrument

(76) Inventor: James A. Nicholson, Hattiesburg, MS (US)

Correspondence Address: Ralph A. Dowell of DOWELL & DOWELL P.C., 2111 Eisenhower Ave, Suite 406, Alexandria, VA, 22314, US

(21) Appl. No.: 12/320,036

(22) Filed: Jan. 15, 2009

Related U.S. Application Data
(60) Provisional application No. 61/021,274, filed on Jan. 15, 2008.

(51) Int. Cl. A61C 3/00; A61C 7/12

(52) U.S. Cl. 433/3; 433/8

(57) ABSTRACT

A wire disengagement tool for removing an archwire from an archwire slot of a self-ligating orthodontic bracket, including a handle, a center arm, and at least one side arm for grasping a portion of the archwire extending laterally from the bracket. The center arm includes a head portion having an engagement surface for contacting inner flanges of upper portions of at least one tie wing of the bracket. In use, the tool is placed on a bracket so that the side arm engages the archwire along side of the bracket and the head portion of the center arm contacts a retentive component of the bracket, such as a tie wing. An orthodontist then applies a downward force, and the head portion yields a lateral wedge-like force on the retentive component so that the retentive component flexes laterally and outwardly to provide access to the archwire. The archwire is grasped between the side arms and the head portion of the center arm and easily lifted from the archwire slot.

### CROSS-REFERENCE TO RELATED APPLICATIONS

This application claims priority to U.S. provisional application No. 61/021,274, filed Jan. 15, 2008, and entitled “Wire Disengagement Instrument,” the subject matter of which is incorporated by referenced in its entirety herein.

### BACKGROUND OF THE INVENTION

1. Field of the Invention

This invention is generally directed to an orthodontic instrument, namely a wire disengagement tool, that includes at least one center portion and at least one lateral fingerlike projection that selectively engages an orthodontic bracket and an archwire to disengage and remove the archwire from an archwire slot in the bracket. More specifically, the invention is directed to a wire disengagement tool for the removal of an archwire from the archwire slot of a self-ligating orthodontic bracket that is at least partially formed from shape memory metallic or non-metallic materials.

2. Brief Description of Related Art

The traditional orthodontic appliance system consists of brackets that are attached directly to a patient's teeth and an archwire that is secured in an archwire slot of each bracket generally by the use of elastomeric and/or metallic ligatures. A new self-ligating orthodontic system, which has become increasingly popular, consists of brackets that do not require the use of elastomeric and/or metallic ligatures to secure and hold an archwire in the archwire slot of a bracket. The new system employs brackets with self-contained retentive mechanisms, such as clips or latches, that make it possible for an orthodontist to place the archwire into the brackets more quickly in a less complicated manner. While the additional components, namely the self-contained clips or latches, make these brackets larger, bulky, and cumbersome to use in the tight confines of a crowed malocclusion that is often seen in orthodontic cases, many orthodontists find the use of self-ligating brackets with clips and latches to be an improvement over conventional orthodontic systems.

Another recent improvement in orthodontic appliances has been the introduction of orthodontic brackets including shape memory materials that can flex to receive and hold an archwire. These self-ligating brackets include at least one retentive component, usually a tie wing, which is at least partially made from a shape memory material and as a result, the bracket construction is smaller and a more compact functional design. The placement of an archwire into an archwire slot of the at least partially formed shape memory self-ligating bracket is accomplished more easily because the archwire exerts a wedge-type lateral force against beveled inner flanges of the tie wing posts of each of bracket tie wings which causes the posts to flex laterally and outwardly to receive and retain the archwire into the archwire slot. The tie wing posts then return to their original predetermined position, thereby retaining the archwire in the archwire slot. Specifically, the undersides of the inner portions of the tie wing flanges extend longitudinally along the length of the archwire slot of the tie wing to form a roof of the archwire slot to hold the archwire in the archwire slot.

While the new orthodontic systems which have replaced the conventional elastomeric and metallic ligatures with new and improved retentive components, such as clips, latches, and shape memory materials, these self-ligating systems do present certain drawbacks. For example, with reference to a bracket utilizing at least one clip to secure an archwire, while it is often easy to place an archwire into the clip, it is quite difficult to remove the archwire due to the shape of the clip. Similarly, with regard to a bracket having at least one latch to secure an archwire, the size and bulk of the latch makes it difficult to insert and remove the archwire to and from the archwire slot. As a further example in regard to a bracket having a self-contained retentive component at least partially formed from a shape memory material, the ability of the inner portions of the tie wing flanges to return to their original positions and cover the archwire slot makes it difficult for an orthodontist to disengage and remove the archwire to adjust and/or replace the archwire at the appropriate time during the orthodontic treatment. Specifically, if the orthodontist attempts to pull the archwire vertically out of the archwire slot, the pressure that would be required to deflect the tie wing flanges outwardly from their original positions will cause pain and discomfort to the patient. Not only can this force result in pain and even injury to the patient, it also creates a risk that a bond securing the bracket to the patient's tooth may be broken, thereby dislodging the bracket from the tooth.

### SUMMARY OF THE INVENTION

The present invention is directed to the use of an orthodontic instrument, namely a wire disengagement tool, that engages an orthodontic bracket having at least one self-contained self-ligating retentive component, such as a clip, latch, or a tie wing at least partially formed from a shape memory material, and an archwire retained by the bracket so as to cause the retentive component of the bracket to flex laterally to facilitate the disengagement and removal of the archwire from the archwire slot and bracket. The wire disengagement tool includes a handle, a center arm, and at least one side arm for grasping a portion of the archwire extending laterally from the bracket. The center arm includes a head portion having an engagement surface for contacting the retentive component of the bracket.

In use, the tool is placed on an orthodontic bracket so that the at least one side arm engages the archwire along side of the bracket and the head portion of the center arm contacts the retentive component. Once the tool is in place, an orthodontist applies a downward force to the head portion of the center arm. As a result of the downward force, the head portion yields a lateral wedge-like force on the retentive component so that the retentive component flexes laterally and outwardly to provide access to the archwire. The archwire is grasped between the side arms and the head portion of the center arm and easily lifted from the archwire slot. As a result, this new orthodontic instrument will make the removal of the archwire from self-ligating bracket systems a smooth, efficient, and much simpler process and will significantly enhance and improve the orthodontic experience and treatment for both the orthodontist and patients.

### BRIEF DESCRIPTION OF THE DRAWINGS

A better understanding of the invention will be had with reference to the attached drawings wherein:

FIG. 1 is a front perspective view of a twin bracket embodiment showing opposing tie wings being flexed outwardly from their original positions as an archwire is inserted therebetween into an archwire slot;

FIG. 2 is a front perspective view of the twin bracket embodiment illustrated in FIG. 1 showing the opposing tie wings in their original positions covering the archwire slot and the archwire therein;

FIG. 3 is a front perspective view of the twin bracket embodiment illustrated in FIG. 1 showing the wire disengagement tool of the present invention engaging the bracket;

FIG. 3A is a side view of bracket and wire disengagement tool illustrated in FIG. 3;

FIG. 3B is a side view of the bracket and wire disengagement tool illustrated in FIG. 3 showing the wire disengagement tool of the present invention engaging an archwire retained in an archwire slot of the bracket;

FIG. 4 is a front perspective view of the twin bracket embodiment illustrated in FIG. 1 showing an alternate embodiment of the wire disengagement tool of the present invention engaging the bracket, wherein the wire disengagement tool includes a grasping means on each side arm;

FIG. 4A is a side view of bracket and wire disengagement tool illustrated in FIG. 4;

FIG. 4B is a side view of the bracket and wire disengagement tool illustrated in FIG. 4 showing the wire disengagement tool of the present invention engaging an archwire retained in an archwire slot of the bracket;

FIG. 5 is a front perspective view of the twin bracket embodiment illustrated in FIG. 1 showing an alternate embodiment of the wire disengagement tool of the present invention engaging the bracket, wherein a head portion of the center arm of the wire disengagement tool has a triangular cross-section;

FIG. 5A is a side view of bracket and wire disengagement tool illustrated in FIG. 5;

FIG. 5B is a side view of the bracket and wire disengagement tool illustrated in FIG. 5 showing the wire disengagement tool of the present invention engaging an archwire retained in an archwire slot of the bracket;

FIG. 6 is a front perspective view of the twin bracket embodiment illustrated in FIG. 4 showing an alternate embodiment of the wire disengagement tool of the present invention engaging the bracket, wherein the head portion of the center arm of the wire disengagement tool has a triangular cross-section;

FIG. 6A is a side view of bracket and wire disengagement tool illustrated in FIG. 6;

FIG. 6B is a side view of the bracket and wire disengagement tool illustrated in FIG. 6 showing the wire disengagement tool of the present invention engaging an archwire retained in an archwire slot of the bracket;

FIG. 7 is a front perspective view of the twin bracket embodiment illustrated in FIG. 1 showing an alternate embodiment of the wire disengagement tool of the present invention engaging the bracket, wherein the head portion of the center arm of the wire disengagement tool has a generally V-shaped cross-section;

FIG. 7A is a side view of bracket and wire disengagement tool illustrated in FIG. 7;

FIG. 7B is a side view of the bracket and wire disengagement tool illustrated in FIG. 7 showing the wire disengagement tool of the present invention engaging an archwire retained in an archwire slot of the bracket;

FIG. 8 is a front perspective view of the twin bracket embodiment illustrated in FIG. 4 showing an alternate embodiment of the wire disengagement tool of the present invention engaging the bracket, wherein the head portion of the center arm of the wire disengagement tool has a generally V-shaped cross-section;

FIG. 8A is a side view of bracket and wire disengagement tool illustrated in FIG. 8;

FIG. 8B is a side view of the bracket and wire disengagement tool illustrated in FIG. 8 showing the wire disengagement tool of the present invention engaging an archwire retained in an archwire slot of the bracket;

FIG. 9 is a side view of an alternative embodiment of the wire disengagement tool of the present invention, wherein the head portion of the center arm of the wire disengagement tool has a toothed engaging surface comprising a plurality of teeth each having a triangular cross-section;

FIG. 9A is a side view of another embodiment of the wire disengagement tool of the present invention, wherein the head portion of the center arm of the wire disengagement tool has a toothed engaging surface comprising a plurality of teeth each having a rectangular cross-section;

FIG. 9B is a top view of the toothed engaging surface of the wire disengagement tool illustrated in FIG. 9A; and

FIG. 10 is a side view of another embodiment of the wire disengagement tool of the present invention, wherein the head portion of the center arm of the wire disengagement tool has a padded engaging surface.

### DETAILED DESCRIPTION OF THE PREFERRED EMBODIMENT

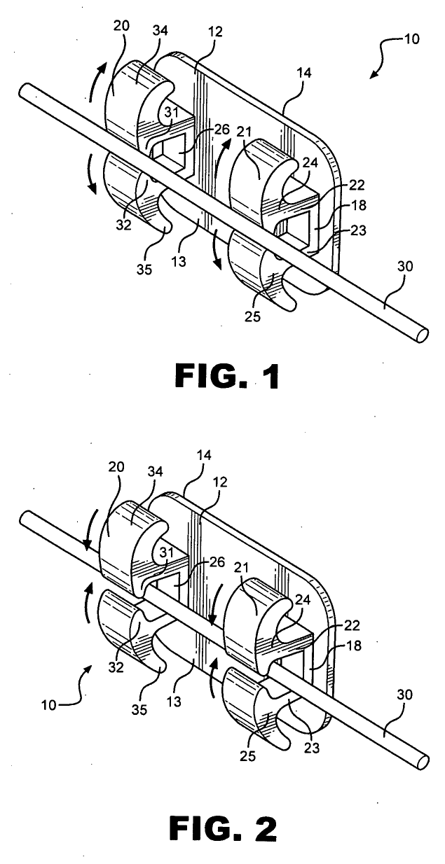

An orthodontic bracket 10 preferably comprises a unitary body structure including a contoured base 12 with a front surface 13 and a rear tooth engaging surface 14. The rear surface 14 is generally slightly concavely contoured so as to match the surface contour of a patient's tooth. The bracket 10 further comprises a retentive component, such as a tie wing, clip, or latch, for retaining an archwire. As shown in at least FIGS. 1 and 2, the bracket 10 is preferably a twin bracket having a pair of spaced opposing tie wings 20 and 21. However, the bracket 10 may be any type of orthodontic bracket, including a single tie wing bracket, and the bracket 10 may include any number of tie wings, which may be positioned in various positions on the bracket 10. Further, the bracket 10 may include attachments or features, such as Kobayashi hooks, removeable hook pins, clips, latches, ligature wires, directional force elastics, elastomeric ligatures, elastomeric power chains, uprighting springs, slots, such as vertical slots, hooks, central recesses, scribe lines, such as vertical scribe lines, and identification recesses, such as colored identification recesses.

Each of the tie wings 20 and 21 includes a base portion 18 from which extend a pair of tie wing posts 22 and 23. Alternatively, the tie wings 20 and 21 are formed such that the posts extend upwardly from the front surface 13 of the bracket base 12. Each of the tie wing posts 22 and 23 includes an upper head portion 24 and 25, respectively. Each pair of the generally parallel posts 22 and 23 define an archwire guide slot 26 of approximately 0.018 to 0.022 inch therebetween to slidingly engage an archwire 30.

The bracket 10 of the present invention is self-ligating, so at least a portion of the bracket 10, namely the retentive component, is formed from a shape memory material. The shape memory material is preferably a nickel-titanium material, but any suitable material, such as metallic materials, including alloys, and non-metallic materials, including resins and polymer-type materials, that exhibit a shape memory may be used. In the preferred embodiment, both of the opposing pair of tie wings 20 and 21 are at least partially formed of a material which allows the tie wings 20 and 21 to flex to permit insertion or removal of the archwire 30 relative to the guide slot 26. When the posts 22 and 23 are flexed from a predetermined original or rest position, as shown by the arrows in FIG. 1, the head portions 24 and 25 of each tie wing separate to permit the insertion or removal of the archwire 30. Once force is removed, the posts 22 and 23 return to their original predetermined position, as shown by the arrows in FIG. 2.

To securely retain an archwire 30 within the guide slot 26, each head portion 24 and 25 of each tie wing post 22 and 23, respectively, includes an inner opposing flange 31 and 32, respectively. The inner flanges 31 and 32 are spaced at a distance of approximately 0.010-0.014 inch which is smaller than the diameter of the archwire 30. In some embodiments, the flanges 31 and 32 may actually touch one another such that the distance is zero. Further, the inner flanges 31 and 32 may be the same size or different sizes.

Each head portion 24 and 25 of each tie wing post 22 and 23, respectively, further includes an outer tie wing flange 34 and 35, respectively, which may be used in a conventional manner to secure archwires with ligature wires and other attachments during patient treatment, as necessary. In the preferred embodiments, the entire outer surface of each of the head portions 24 and 25 is shown as being generally convex with the inner flanges 31 and 32, respectively, tapering downwardly and inwardly relative to one another.

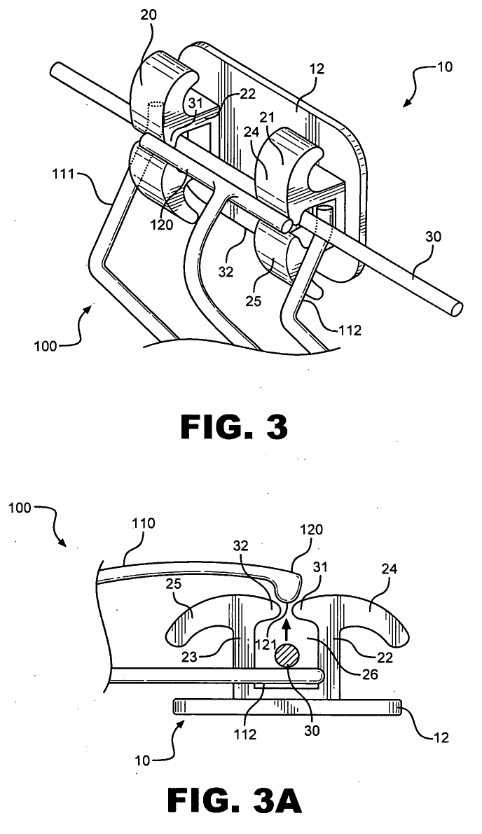

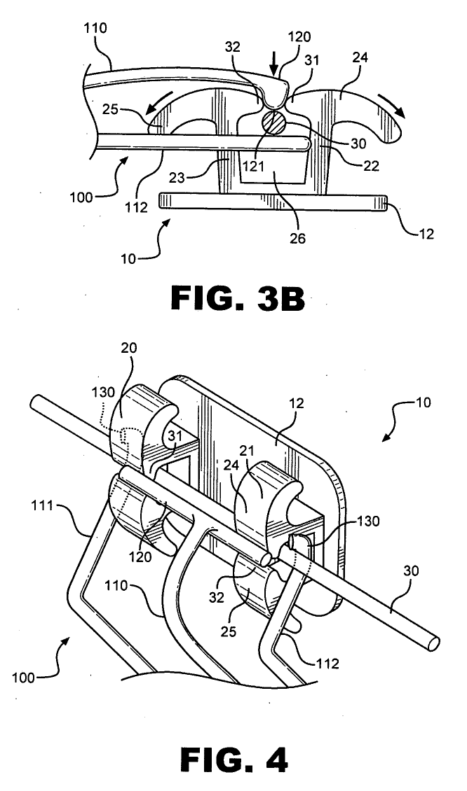

To disengage and remove the archwire to adjust and/or replace the archwire, a wire disengagement tool 100 can be used. As shown in FIGS. 3, 3A, and 3B, the wire disengagement tool 100 comprises a center arm 110 and side arms 111 and 112 located on either side of the center arm 110. The center arm 110 and the side arms 111 and 112 are attached to a handle, which is gripped by an orthodontist when the tool 100 is in use. The handle may extend in the same plane as the center arm 110 and the side arms 111 and 112, or the handle may extend perpendicularly from the center arm 110 and the side arms 111 and 112. Further, the handle may be a unitary structure, but the handle preferably includes two moveably mounted components, wherein a first handle component is attached to the center arm 110 and a second handle component is attached to the side arms 111 and 112 so that the tool 100 acts in a plier-like manner.

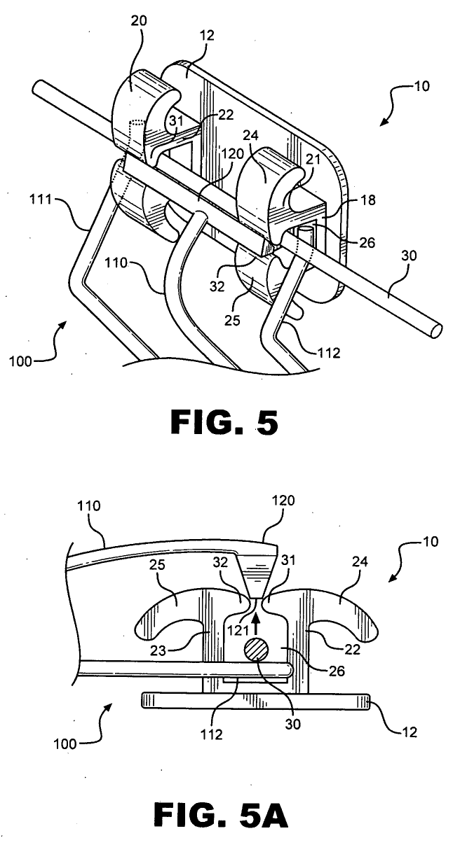

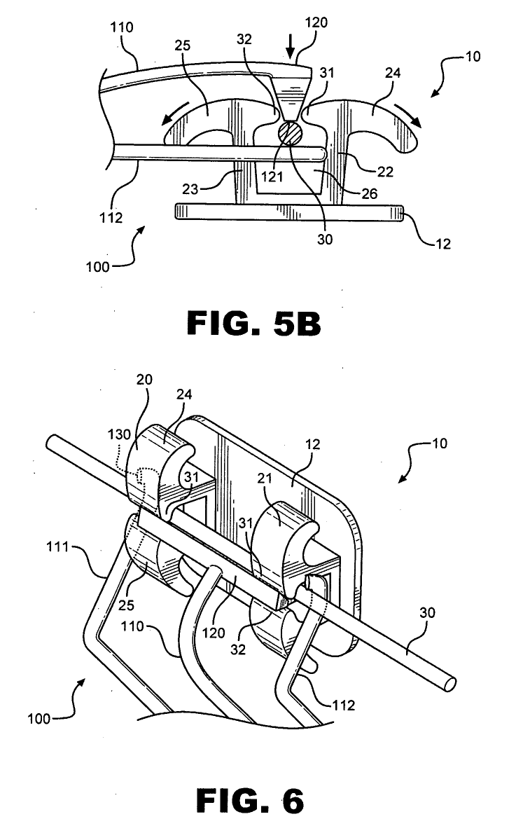

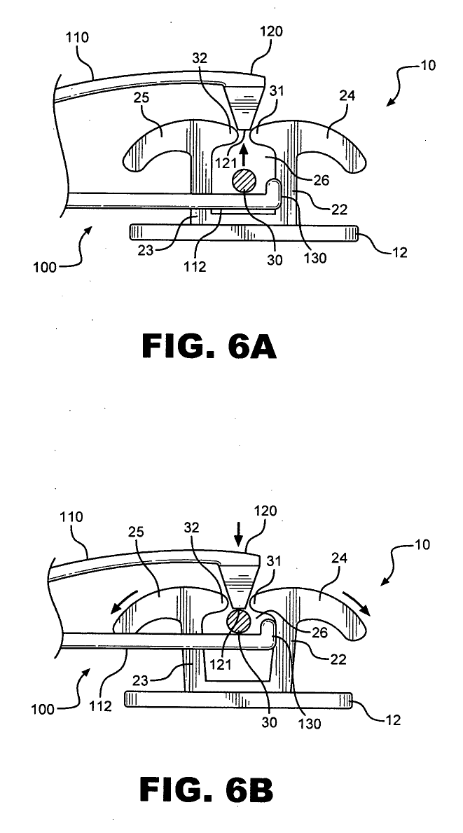

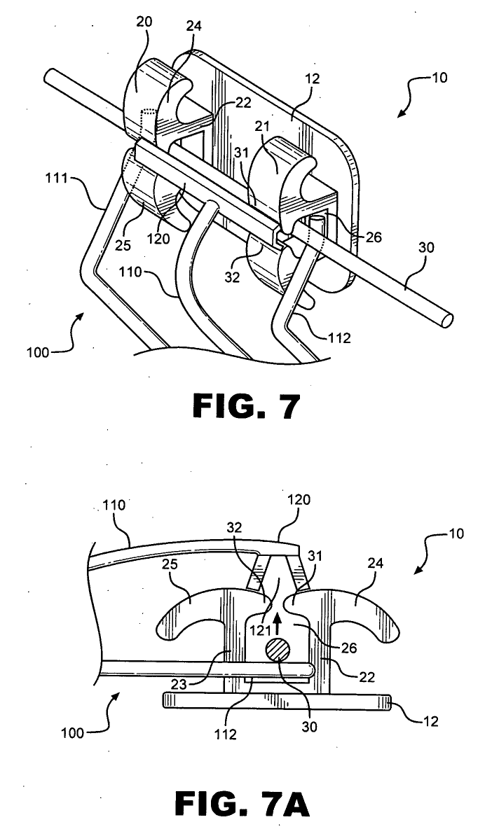

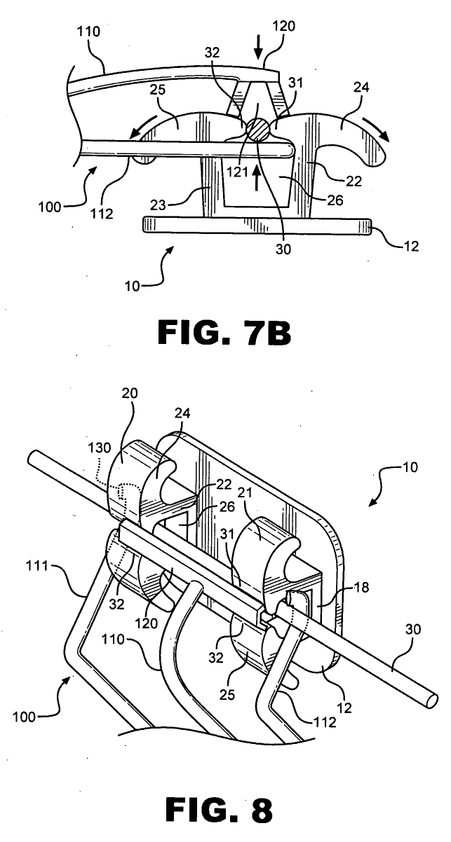

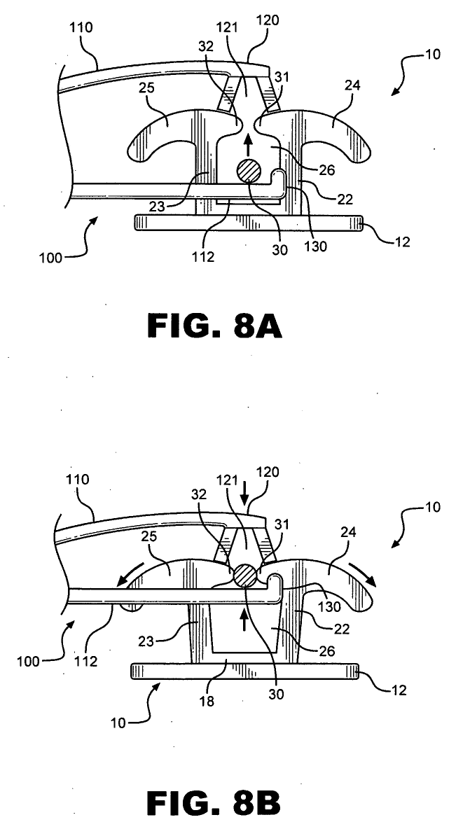

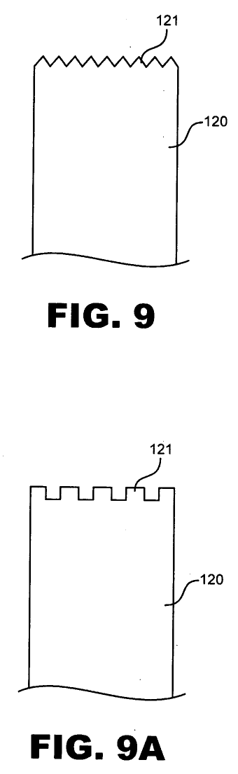

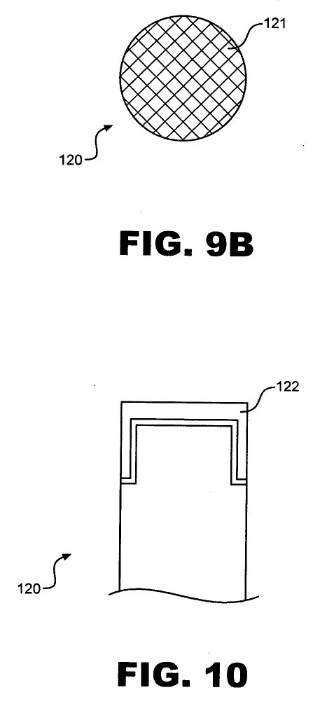

The center arm 110 includes a head portion 120, which extends transversely from the center arm 110 toward each of the side arms 111 and 112. As shown in FIGS. 3A and 3B, the head portion 120 has a generally round cross-section. However, the head portion 120 may have any suitable shape and cross-section, such as a triangular cross-section shown in FIGS. 5A, 5B, 6A, and 6B or a generally V-shaped cross-section shown in FIGS. 7A, 7B, 8A, and 8B. The head portion includes an engagement surface 121 which engages at least one tie wing of a bracket 10 when the tool 100 is in use. Preferably, the engagement surface 121 is a serrated or toothed surface to securely engage a tie wing, as shown in FIGS. 9, 9A, and 9B. Further, the teeth of the engagement surface 121 may be triangular in cross-section, as shown in FIG. 9A, rectangular in cross-section, as shown in FIG. 9B, or any other suitable shape or cross-section. The engagement surface 121 may include a pad or cushion 122, as shown in FIG. 10, so that the head portion 120 can more effectively contact the tie wings 20 and 21 of the bracket 10. Further, to create an even more precise engagement between the engagement surface 121 of head portion 120 and the tie wings 20 and 21, the upper portions 24 and 25 of the tie wings 20 and 21 may include depressions or recesses to receive the engagement surface 121. In addition, any suitable engagement means may be used to create a precision engagement between the engagement surface 121 and the tie wings 20 and 21 of the bracket 10.

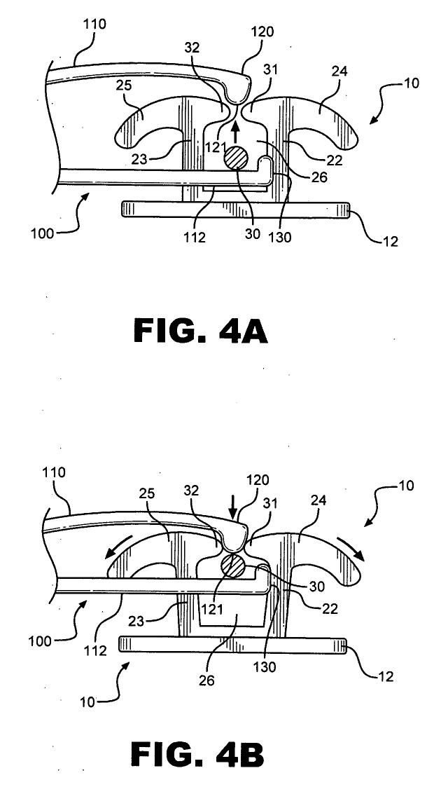

Each of the side arms 111 and 121 preferably includes a grasping means 130 for grasping an archwire 30 when the wire disengaging tool 100 is in use. The grasping means 130 is preferably a hook 131, as shown in FIGS. 4, 4A, 4B, 6, 6A, 6B, 8, 8A, and 8B. However, any suitable means for engaging an archwire 30 may be used.

As shown in FIGS. 3-8B, to use the wire disengagement tool 100 to disengage and remove an archwire 30 from an archwire slot 26 of an orthodontic bracket 10, the tool 100 is placed against the bracket 10 so that the side arms 111 and 112 are placed underneath the archwire 30 on either side of the bracket 10. The center arm 110 is placed between the retentive component, namely tie wings 20 and 21, so that the head portion 120 of the center arm 110 engages the upper portions 24 and 25 of the tie wings 20 and 21. When the head portion 120 contacts the upper portions 24 and 25 of the tie wings 20 and 21, the engaging surface 121 of the head portion 120 contacts the inner flanges 31 and 32 of the upper portions 24 and 25, respectively.

Once the tool 100 is positioned on the bracket 10, a downward force toward the archwire slot 26 is applied to the head portion 120. As a result of the downward force, the head portion 120 creates a wedge-like lateral force against the inner flanges 31 and 32 of the upper portions 24 and 25, respectively, of each of the tie-wings 20 and 21 to cause the tie wings 20 and 21 to flex laterally and outwardly to make the archwire 30 in the archwire slot 26 accessible, as shown in FIG. 3B. As the head portion 120 of the center arm 110 maintains the tie wings in flexed, outwardly-extended position, the side arms 111 and 112 lift the archwire 30 toward the head portion 120 so that archwire 30 is retained in a friction fit between the head portion 120 and the side arms 111 and 112. After the archwire 30 is retained between the head portion 120 and the side arms 111 and 112, the archwire can be lifted vertically from the archwire slot 26. Finally, the wire disengaging tool 100 is removed from the bracket, and the tie wings 20 and 21 return to the original rest positions.

The foregoing description of the present invention has been presented to illustrate the principles of the invention and not to limit the invention to the particular embodiments illustrated. It is intended that the scope of the invention be defined by all of the embodiments encompassed within claims and their equivalents.

I claim:

1. An orthodontic instrument for removing an archwire retained in an orthodontic bracket having a bracket base and at least one retentive component, the instrument comprising:
a center arm having a head portion extending transversely from a longitudinal axis of said center arm, said center arm being designed to engage the at least one retentive component of the orthodontic bracket;
at least one side arm located adjacent said center arm, said at least one side arm being designed to be placed between the archwire and the base of the bracket so that the archwire is supported between said center arm and said at least one side arm; and
a handle secured to said center arm and said at least one side arm, said handle being designed to enable a user to engage said center arm against the at least one retentive component of the bracket and to place said at least one side arm between the archwire and the base of the bracket so that when the user applies a downward force to said center arm toward the base of the bracket, said head portion of said center arm creates a wedge-like lateral force against the at least one retentive component so that the archwire supported between said center arm and said at least one side arm can be removed from the orthodontic bracket.

2. The orthodontic instrument of claim 1, wherein said handle includes a first component attached to said center arm and a second component attached to said at least one side arm and pivotally connected to said first component so that the orthodontic instruments acts in a plier-like manner.

3. The orthodontic instrument of claim 1, wherein said at least one side arm includes a grasping means for grasping the archwire.

4. The orthodontic instrument of claim 1, wherein said head portion of said center arm includes an engagement surface for engaging the at least one retentive component of the bracket.

5. The orthodontic instrument of claim 4, wherein said engagement surface has a rounded cross-section.

6. The orthodontic instrument of claim 4, wherein said engagement surface has a triangular cross-section.

7. The orthodontic instrument of claim 4, wherein said engagement surface has a V-shaped cross-section.

8. The orthodontic bracket of claim 4, wherein said engagement surface is textured.

9. The orthodontic bracket of claim 8, wherein said texture of said engagement surface is selected from the group consisting of serrations, teeth each having a rectangular cross-section, teeth each having a triangular cross-section, and any combination thereof.

10. The orthodontic bracket of claim 4, wherein said engagement surface is padded.

11. An orthodontic instrument for removing an archwire retained in an orthodontic bracket having a bracket base and at least one retentive component, the instrument comprising:
a center arm having a head portion extending transversely from a longitudinal axis of said center arm, said center arm being designed to engage the at least one retentive component of the orthodontic bracket;
a first side arm located adjacent said center arm on a first side thereof and a second side arm adjacent said center arm on a second side thereof so that said center arm is positioned between said first and second side arms, said first and second side arms being designed to be placed between the archwire and the base of the bracket so that the archwire is supported between said center arm and said first and second side arms; and
a handle secured to said center arm and said first and second side arms, said handle being designed to enable a user to engage said center arm against the at least one retentive component of the bracket and to place said first and second side arms between the archwire and the base of the bracket on either side of said center arm so that when the user applies a downward force to said center arm toward the bracket base, said head portion of said center arm creates a wedge-like lateral force against the at least one retentive component so that the archwire supported between said center arm and said first and second side arms can be removed from the orthodontic bracket.

12. The orthodontic instrument of claim 11, wherein said handle includes a first component attached to said center arm and a second component attached to said first and second side arms and pivotally connected to said first component so that the orthodontic instruments acts in a plier-like manner.

13. The orthodontic instrument of claim 11, wherein at least one of said first and second side arms includes a grasping means for grasping the archwire.

14. The orthodontic instrument of claim 11, wherein said head portion of said center arm includes an engagement surface for engaging the at least one retentive component of the bracket.

15. The orthodontic instrument of claim 14, wherein said engagement surface has a rounded cross-section.

16. The orthodontic instrument of claim 14, wherein said engagement surface has a triangular cross-section.

17. The orthodontic instrument of claim 14, wherein said engagement surface has a V-shaped cross-section.

18. The orthodontic bracket of claim 14, wherein said engagement surface is textured.

19. The orthodontic bracket of claim 18, wherein said texture of said engagement surface is selected from the group consisting of serrations, teeth each having a rectangular cross-section, teeth each having a triangular cross-section, and any combination thereof.

20. The orthodontic bracket of claim 4, wherein said engagement surface is padded.
